(19) United States
(12) Patent Application Publication
(10) Pub. No.: US 2015/0224589 A1
(43) Pub. Date: Aug. 13, 2015

(54) METHOD FOR PRODUCING AN ARBITRARY GEOMETRY ON PISTONS OF INTERNAL COMBUSTION ENGINES

(71) Applicants: Janssen Albert Michael, Mosbach (DE); Gniesmer Volker, Alfed (DE); Karl Diffenbach, Langrenbrettach (DE); Gerhard Luz, Nordheim (DE)

(72) Inventors: Janssen Albert Michael, Mosbach (DE); Gniesmer Volker, Alfed (DE); Karl Diffenbach, Langrenbrettach (DE); Gerhard Luz, Nordheim (DE)

(73) Assignee: KS KOLBENSCHMIDT GMBH, Neckarsulm (DE)

(21) Appl. No.: 14/622,086

(22) Filed: Feb. 13, 2015

Related U.S. Application Data
(63) Continuation of application No. 13/697,415, filed on Nov. 12, 2012, now abandoned.

(51) Int. Cl. B23H 3/10; F02F 3/18; F02F 3/00; B23P 15/10

(52) U.S. Cl. CPC B23H 3/10; B23P 15/10; F02F 3/18; F02F 3/003

(57) ABSTRACT

A method for processing a constructed, liquid-cooled piston of an internal combustion engine, the piston including an upper piston part and a lower piston part, which are supported by a joining plane and are connected to each other in a bonded manner. An electrochemical method, such as electrochemical machining, is used to produce a passage opening or a hole in the piston. By means of the method, material is selectively removed after the completion of the upper part piston, the lower piston part, or the piston after the two piston parts have been joined. The electrochemical machining allows an arbitrarily geometrically designed topography having at least one passage opening, a hollow, or an oil pocket in cooling areas or non-cooling areas to be created on the piston.

### CROSS-REFERENCE TO CO-PENDING APPLICATION

This application is a continuation of co-pending U.S. patent application Ser. No. 13/697,415 filed Nov. 12, 2012, for a METHOD FOR PRODUCING A COOLING CHANNEL SYSTEM FOR INTERNAL COMBUSTION ENGINES AND PISTON PRODUCED BY THIS METHOD, which claims priority to PCT/EP2011/000664 filed Feb. 12, 2011, the entire contents of which are incorporated herein in its entirety.

### BACKGROUND

The invention relates to a method for machining a single-piece or assembled, liquid-cooled piston of an internal combustion engine that includes a piston upper part and a piston lower part. To produce an opening or hole in the piston, electrochemical machining is used as an electrochemical method with which a metallic material can be removed.

For pistons of internal combustion engines (single-piece cast or forged pistons or multi-piece assembled pistons in which the parts are joined together detachably or non-detachably using a force fit and/or in a bonded manner), known primary forming methods such as casting and forging were used previously to produce a free-form surface topography. In the case of casting, complicated tools are involved, specifically, casting cores, and, in the case of forging, draft angles for the forging tool must be taken into account. These primary forming methods also have the disadvantage of a rough surface structure. The geometries on finished pistons to be produced by mechanical machining extend currently to rotationally symmetrical measures, such as turning and drilling or plane milling operations. Regardless of the mechanical measures employed, these measures require costly deburring.

It is known from DE 199 59 593 A1 to employ an ECM method (electrochemical machining) as an alternative to mechanical machining to produce holes. The basic principle of electrochemical material removal is the same as that of an electrolytic cell in which a system comprising workpiece-electrolyte-tool forms the electrolytic cell in which, with the use of suitable electrolyte solutions, the anode goes into solution because of charge exchanges. The electrolyte solution flows through a machining gap between the anode (workpiece) and the cathode (tool) whereby hydrogen ions are discharged at the cathode. The resulting metal ions on the anode react with suitable partners forming metal hydroxide compounds that are picked up and carried away by the electrolyte flow. Electrochemical machining is a reversal of the process of galvanizing.

It would be desirable to provide a method by which arbitrarily shaped topographies can be created on finished piston parts or on a finished piston through an electrochemical process, such as electrochemical machining.

### SUMMARY

An electrochemical machining method (ECM) is applied after the completion of the piston upper part or piston lower part, respectively, or after joining these piston parts, or after completion of the single-piece piston. The method allows the removal of material from a finished piston or finished piston part to create arbitrarily geometrically shaped topographies configured as a recess, a passage opening, a hole, an oil pocket, or a contour or surface in or on the piston. This method is carried out without mechanical damage to the surrounding surfaces of the components produced by the processes of casting or forging. A further feature of the method is the high degree of dimensional accuracy and surface quality, and material removal to match the final contour precisely. This electrochemical machining, which can be implemented with short process times, can be used for cooling areas of the piston as well as for non-cooling areas.

One feature is that good reproducibility is achieved in one step with simultaneous high dimensional accuracy and surface quality while there is no resulting tool wear. Cold material removal in the electrochemical machining method additionally has no thermal effect nor does it cause distortion of the microstructure. Furthermore, there are neither significant forces from machining nor distortion in the piston, while the machining process is simultaneously completely burr-free. The properties of the method, also known as electrochemical machining, is great design freedom, even for complex spatial forms. The method also allows flexible design in the shaping of measures for coolant supply and/or for coolant contact with the piston that can be implemented without loss of design strength and that could not be realized previously, or only to a limited extent. The method does not require any additional expense for deburring and, as a result, production costs are reduced.

As a result of the use of the method, cooling channels, cooling spaces or locally expanded oil pockets to optimize cooling of the piston can be produced where all transitions are first rounded. Optional configurations for holes, passage openings or recesses to supply or remove coolant can be curved, non-circular, oval, or elongated holes. Further, the cross-section of an opening or hole can be changed over its length. Using the process, all edges are rounded and thus any danger to design strength is significantly reduced compared with mechanical machining. The surface structure that can be obtained promotes the flow of a coolant so that this machining can be used to create passages, openings or recesses through which a lubricating or cooling medium flows in or is removed. Similarly, oil removal pockets with a free shape can be located on the flanks of the grooves. These pockets are characterized in that the transitions on the flank of the groove and towards the bottom of the groove are completely rounded. Where necessary, the bottom of the groove is included in the design so that the oil behind the ring can be led away via the pocket. Furthermore, the pockets can be configured to pass completely through the last ring land. A further feature is the oil pockets can be formed with a free shape in the bolo area, as well as the oil grooves in the piston pin area to ensure optimal lubrication of the pin.

The ECM method also makes it possible to create complex, three-dimensional free-form surfaces on the finished piston. As a result, the piston can be adapted to special requirements with regard to its function, such as optimization of the cooling function, optimization of the cooling medium flow, or optimization of weight. This is achieved by a process that is more cost-effective and less restricted by comparison with the alternative production options.

The application of electrochemical material removal in accordance with the method permits great freedom in design with respect to the alignment, the path and the size of free-form surfaces, recesses or contours. One feature lies in the fact that there is no restriction regarding geometric shaping. Thus, contours in three-dimensions, running straight or curved, or passages with circular or non-circular cross-sectional profiles and diameters that vary over their length can be realized. Furthermore, the method also allows trumpet-shaped, non-rotationally symmetrical holes to be created. The shape that can be realized is determined by the direction in which the working cathode (electrode) is fed, which has to be moved again in the opposite direction after the topography created has been completed. This feed direction can, depending on the electrode shape, which is determined by the geometry to be cut, also be irregular or run in a curve, whereby contours with undercuts can advantageously be produced with the method used.

Piston production in which electrochemical machining is used for the selective removal of the material on or in the piston is carried out in the following steps. To produce the piston lower part and the piston upper part of the assembled piston or of a single-piece piston, a forging or casting process is used as the primary forming process. Then, after the necessary mechanical operations have been concluded, to complete the process the piston component is cleaned of lubricants and/or cutting fluids that were used during the mechanical machining, to remove, for example, any chips that may be adhering. Electrochemical machining is employed for finish or final machining of individual surfaces or to create recesses, openings or contours with arbitrary geometric shapes. Finally, in the case of the assembled piston, the piston lower part and the piston upper part are joined, supported by a joining zone and held together in a bonded manner by means of a weld or frictionally by means of a screw connection. As an alternative, using electrochemical machining, it is possible to introduce, for example, a passage opening between the cooling space and a cooling channel after the piston lower part and the piston upper part have been joined, that is to say, in the finished part.

Electrochemical machining includes the following steps. First, the piston or the piston component is placed, either manually or automatically, into a fixture in which the piston is calibrated, aligned to a zero position and locked in place. Then the cathode is lowered and aligned to the area of the piston to be machined. The further steps in the method are the application of a voltage, or a current, and flushing or bathing the cathode with an electrolyte medium, where the voltage applied, or the current applied, can be regulated throughout the time of the procedure. For finish machining, the working cathode is brought to the piston or the piston component along a consistently curved feed line for the purpose of removing material to obtain the predetermined geometry or topography.

One feature of using electrochemical machining is that the machining can be used for piston components or the entire piston regardless of the manufacturing process, forging or casting, and the metal materials employed. Consequently, piston components of the same or different materials are machined, in which, for example, aluminum and/or steel constitute the primary alloying element, or one piston component of steel is combined with a further piston component of light alloy.

The electrochemical method can be used to generate simple or complicated free-form surfaces on piston components. It is also possible to use the method to introduce recesses, passage openings or holes between a cooling space and the cooling channel in the piston upper part or the piston lower part or to enlarge, or optimize, the size of cooling spaces. Recesses or oil pockets can further be created by electrochemical machining in the cooling space or in the area of the piston pin bore of the piston lower part. Electrochemical machining can additionally be used for reworking or final machining of openings, holes or contours already introduced into a piston component.

To carry out the method, a suitable fixture is one in which the piston is fixed, and the cathode is mounted in a bracket and carried so that it can be moved. A gap for flowing an electrolyte solution is provided between the workpiece, which is wired as an anode, the piston and the tool—the working cathode (electrode). Electrochemical removal of the material is carried out after applying an electrical voltage, or current, between the anode and the insulated working cathode matched to the shape, for example, of the recess to be created. The cathode is continuously tracked during the process of removal by means of a feed mechanism. To do this, the cathode can be mounted in a bracket in such a way that controlled adjustment takes place corresponding to the removal process. A spring element effects a displacement of the cathode assisted by spring force. The bracket includes, in addition, openings for the entry and exit of the electrolyte solution. Non-conducting spacers on the face turned towards the anode are assigned to the cathode. A linear drive or a numerically controlled drive can also be used as an alternative to the spring element.

### BRIEF DESCRIPTION OF THE DRAWING

Embodiments of the method, to which the method is not restricted, are described in what follows and explained using the Figures in which:

FIG. 1 shows a first aspect of a piston in a sectional drawing with a passage opening in the piston upper part produced in accordance with the method;

FIG. 2 shows a second aspect with a cooling channel in accordance with the method;

FIG. 3 shows a third aspect with an alternative shape for the cooling channel compared with FIG. 2;

FIG. 4 shows a fourth aspect with a cooling space shaped in accordance with the method;

FIG. 5 shows a fifth aspect with a passage opening in the piston lower part produced in accordance with the method;

FIG. 5a shows the cathode to create the passage opening from FIG. 5 in an individual part drawing;

FIG. 5b shows the cathode from FIG. 5a in a further view;

FIG. 6 shows a sixth aspect with a cooling channel in accordance with the method; and

FIG. 7 shows a seventh aspect with two differently configured passage openings.

### DETAILED DESCRIPTION

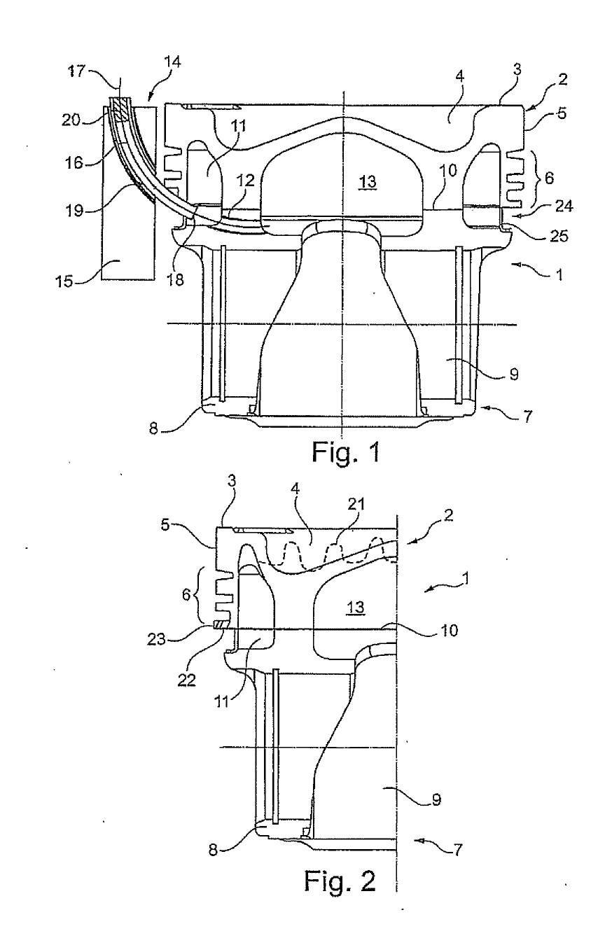

FIG. 1 shows in a sectional view an assembled piston 1 configured as a cooling channel piston consisting of a piston upper part 2 and a piston lower part 7. A piston upper part 2 of the piston 1 is closed off by a piston head 3 into which a combustion chamber recess 4 is introduced centrally. On the outer side, the piston upper part 2 is surrounded by a top land 5 and an adjacent ring area 6. Attached to the piston upper part 2 is the piston lower part 7 that forms a piston skirt 8 that includes diametrically opposite piston pin bores 9 to receive a piston pin not shown in FIG. 1. The components can be produced by a casting or by a forging process, where the piston upper part 2 and the piston lower part 7, are supported by a joining plane 10 and specifically joined in a bonded manner by means of a weld. A radially circumferential cooling channel 11, is produced by means of a soluble casting core, specifically a salt or sand core, is integrated into the piston upper part 2 to cool the piston 1. An insert 25 produced from a temperature-resistant metal material is used to seal an outer circumferential ring gap 24 that results between the ring area 6 and the piston lower part 7. In an operating state, the piston 1 is contacted by a coolant, specifically the lubricating oil of the internal combustion engine, via an injector nozzle, not shown in FIG. 1. The coolant is sprayed into a central cooling space 13 of the piston 1 and reaches the cooling channel 11 by way of at least one passage opening 12. As an alternative, the coolant can be sprayed directly into the cooling channel 11 by the injector nozzle by way of an inlet opening, which is not shown. The coolant leaves the cooling channel 11 by way of at least one exit opening, not shown. As the result of appropriate design and installation location, the cooling channel 11 runs at least in some areas at equal distances from the ring area 6 and the combustion chamber recess 4.

The curved passage opening 12 can be introduced into piston lower part 7 by an electrochemical machining method before the piston 1 is completed, namely, the joining of the piston upper 2 to the piston lower part 7. To this end, the piston lower part 7 is positioned in a fixture 14 that includes a bracket 15 in which a working cathode 16 is guided so as to be moveable. The working cathode 16, which on the outside has an arcuate configuration matching the path of the passage opening 12, is adjustable on a feed line 17 running congruent with the radius of curvature of the passage opening 12. In order to introduce several passage openings 12 into the piston lower part 7 simultaneously, the fixture 14 can be equipped with several suitably positioned working cathodes 16.

A description of the electrochemical machining method follows: in the operating mode, the tool—the working cathode 16 of the fixture 14—is connected to the negative pole, and the workpiece—the piston 1—is connected to the positive pole of a direct current source. Thus, the piston 1 forms the anode, and the working cathode 16 forms the cathode. An electrolyte solution, for example, a sodium chloride solution, flows through the working cathode 16 which is guided in the fixture 14, or the bracket 15. The electrolyte solution flows through the working cathode 16 and flows in the feed direction through a gap 19 out of the face 18 of the working cathode 16 in the direction of the passage opening 12 of the piston 1 to the outside. A spring element 20 impinges on the working cathode 16 in the feed direction. Because of the dissociative effect of the current in conjunction with the electrolyte solution, small material particles are removed which are taken with the electrolyte solution through the gap 19 out of the passage opening 12 in the piston 1. The shape of the working cathode 16 is matched to the path and the desired geometric shape of the recess in the piston 1 from electrochemical machining. As an alternative to the method described, it is possible to use the electrochemical machining method to remove larger amounts of material locally.

FIGS. 2 to 7 show alternative aspects of pistons configured in accordance with the method having differently configured topographies produced by electrochemical machining. Details and areas that have equivalent functions to details and areas described previously have the same reference numerals and are not explained again in detail.

FIG. 2 shows in a half section the piston 1 in which local oil pockets 21 are introduced by electrochemical machining into the piston upper part 2 after the production process and before it is joined to the piston lower part 7. The oil pockets 21 distributed peripherally in the cooling channel 11 effectively enlarge the cooling channel 11 in the direction of the piston head 3. To achieve this, it is possible by means of a fixture to insert one or several working cathodes in a straight line into the cooling channel 11 for the purpose of introducing conically tapering oil pockets 21, rounded at the end, that create a dentate structure inside the cooling channel 11. The piston upper part 2 further includes several oil drain holes 22 produced by electrochemical machining in the lower groove wall 23 pointing to the piston skirt 8.

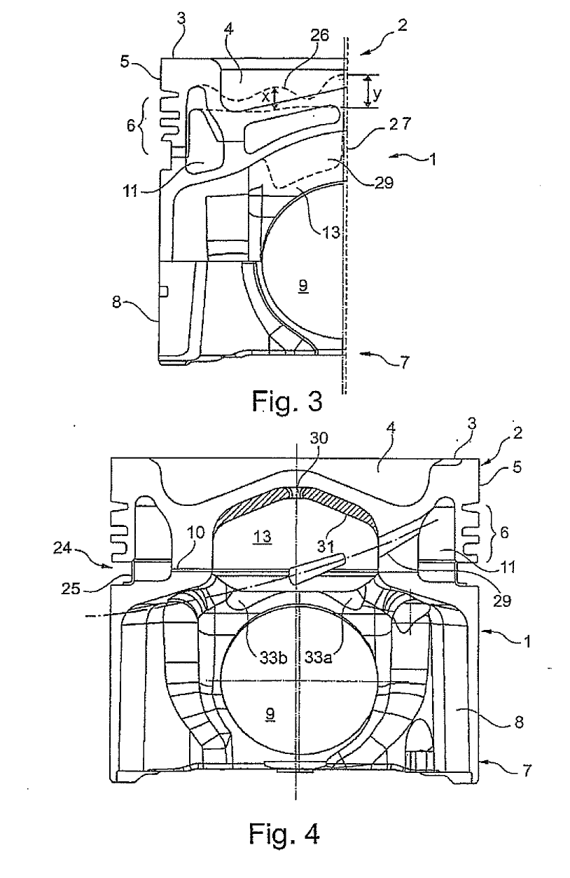

The piston 1 in accordance with FIG. 3 has the cooling channel 11 that forms a profile 26 running in a wavy line that has, for example, divergent depths between a dimension “x” and a dimension “y”. The piston 1 further has, in the area of the cooling space 13, shown as an alternative to FIG. 1, at least one bowl-shaped recess 27 separated by a rib 28. Electrochemical machining is similarly used to create the profile 26 and the recess 27 that are introduced before being joined to the piston upper part 2.

FIG. 4 shows the piston 1 with a conically tapering, arcuate passage 29 running between the cooling space 13 and the cooling channel 11 in the area of the piston upper part 2. Recesses 32 bounded by ribs 30, 31 are introduced in the wall of the cooling space 13 aligned towards the combustion chamber recess 4. The piston lower part 7 further includes oil pockets 33a, 33b running in the direction of the piston pin bore 9.

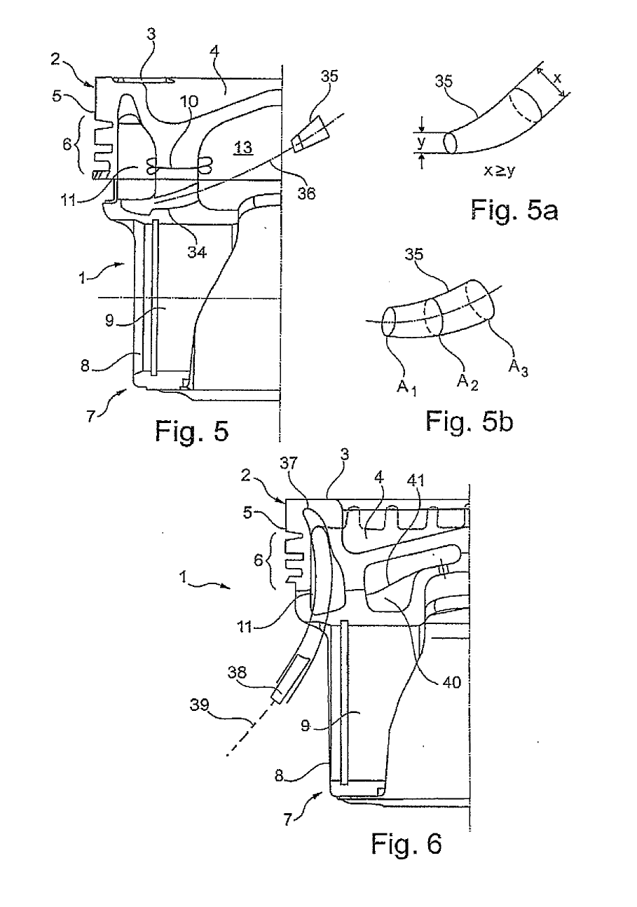

In accordance with FIG. 5, there is a passage opening 34 in the piston lower part 7 rising from the cooling channel 11 to the cooling space 13. The feed line 36 clarifies the infeed of the working cathode 35 to produce the inflow passage 34. FIGS. 5a, 5b show the working cathode 35 that is shaped to match the path of the geometric shape of the passage opening 34. The trumpet shaped working cathode 35 forms a cross-sectional profile configured as an oval standing on end that tapers from a largest diameter “x” to a smallest diameter “y”. The enclosing curved edges of the cathode 35 accordingly stand in a relationship by which the layout is A1≦A2≦A3.

FIG. 6 shows a further application of electrochemical machining to create recesses selectively in the piston 1. According to FIG. 6, the cooling channel 11 has oil pockets 37 arranged offset to each other and running in an arc in the direction of the piston head 3. The working cathode 38 employed to create the oil pocket 37 is carried on a correspondingly arcuate feed line 39. The piston lower part 7 of the piston 1 still includes bowl-shaped recesses 40 introduced by electrochemical machining that are separated by a rib 41.

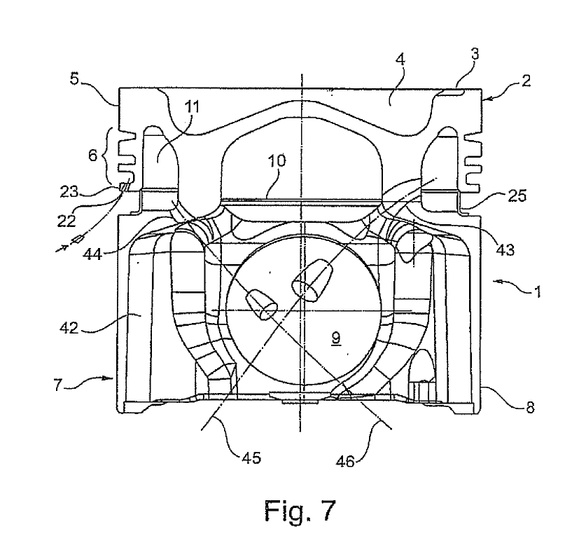

FIG. 7 shows openings and holes that are produced by electrochemical machining on the complete piston after piston upper part 2 and piston lower part 7 are joined. A conical arcuate passage opening 43 runs between a piston inner space 42 and the cooling channel 11. The passage opening 44 lying opposite passage opening 43 shows an alternate shape. The path of these passage openings 43, 44 takes into consideration a potential infeed of the cathodes used that are identified by the appropriate arcuate feed lines 45, 46. In addition, the oil drain holes 22 in the groove wall 23 are introduced by electrochemical machining on the finished piston 1 in the region of the ring area 6.

What is claimed:

1. A method for processing a one-piece or an assembled, liquid-cooled piston of an internal combustion engine that includes a piston upper part and a piston lower part, comprising:
after the respective completion of the piston upper part, the piston lower part or the piston, removing selected material solely by electrochemical machining to create an arbitrary geometrically shaped topography configured as a recess or an oil pocket in one of cooling areas and non-cooling areas in or on the piston.

2. The method from claim 1, wherein:
creating arbitrarily shaped free-form surfaces or contours in the recess or the oil pocket with a three-dimensional shape with and without an undercut.

3. The method from claim 1, comprising:
removing material from local areas of the piston, wherein the machining is carried out in the steps of:
producing a piston lower part and a piston upper part of the piston by a primary forming process;
completing the piston lower part and the piston upper part by mechanical operations;
cleaning the piston components of at least one of cutting fluids and/or lubricants and adhering chips;
final machining by electrochemical machining to create arbitrary geometrically shaped surfaces or contours; and
joining the piston lower part and the piston upper part by means of a bonded connection.

4. The method for removing material from local areas of the piston in accordance with claim 3, wherein the electrochemical machining comprises the steps of:
inserting the piston or a piston component into a fixture and aligning to a zero position and clamping the piston or the piston component;
adjusting and calibrating at least one working cathode guided in a bracket of the fixture;
lowering and aligning the working cathode to an area of the piston to be machined;
applying one of a voltage and a current, and one of flushing and bathing the working cathode with an electrolyte medium, wherein the one of the voltage and the current is regulated over the time of the procedure; and
finish machining by the working cathode, which is guided on a feed line and removes material, where the shape of the working cathode is matched to the contour to be created.

5. The method in accordance with claim 1, wherein the piston components are made the same or different materials and electrochemical machining is used regardless of the material and the method used to produce the piston lower part and the piston upper part.

6. The method in accordance with claim 1, further comprising introducing at least one passage opening between one of a cooling space and a piston inner space and the cooling channel in the piston upper part and the piston lower part by electrochemical machining.

7. The method in accordance with claim 1, further comprising introducing oil pockets to enlarge the cooling channel locally on a combustion chamber side that create a profile similar to one of a tooth and an undulating profile.

8. The method in accordance with claim 6 further comprising:
introducing, by electro chemical machining, recesses separated by lands in the cooling space on a combustion chamber side of the piston.

9. The method in accordance with claim 1 further comprising introducing at least one of one oil pocket and a recess in the area of a piston pin bore of the piston lower part.

10. The method in accordance with claim 1, further comprising:
reworking the recess, or the oil pocket existing in the piston by electrochemical machining.

11. A fixture for performing the method from claim 1, characterized in that the piston is clamped to a fixture in which the working cathode is received in a bracket and is movably carried, and between the workpiece wired as an anode, the piston and the tool, the cathode and the electrode, a gap is provided to flow an electrolyte solution, and a feed device continuously adjusts the cathode to match the material removal process.

12. The fixture from claim 11, wherein the working cathode is controlled in the bracket, and is moveable to match the removal process, where a spring element effects a spring-assisted displacement of the cathode.

13. The fixture from claim 12, wherein openings are provided in the bracket for the entry and exit of the electrolyte solution.

14. The fixture from claim 11, wherein non-conducting spacers are arranged on a face of the working cathode turned towards the piston.
